(19) United States
(12) Patent Application Publication
(10) Pub. No.: US 2006/0109285 A1
(43) Pub. Date: May 25, 2006

(54) Method and apparatus for writing a non-rectangular frame to a display device

(76) Inventors: Victor Ga-Kui Chan, Richmond (CA); Raymond Chow, Richmond (CA)

Correspondence Address: EPSON RESEARCH AND DEVELOPMENT INC;INTELLECTUAL PROPERTY DEPT, 150 RIVER OAKS PARKWAY, SUITE 225, SAN JOSE, CA, 95134, US

(21) Appl. No.: 10/996,004

(22) Filed: Nov. 23, 2004

(51) Int. Cl. G09G 5/00

(52) U.S. Cl. 345/642

(57) ABSTRACT

The invention is directed to an apparatus and method for writing a non-rectangular frame to a display device and for animating window transitions. The apparatus comprises a memory for storing at least one parameter for defining a first aperture boundary and a data selecting part. The data selecting part is adapted for comparing the associated coordinates of each datum of a first frame to the first boundary, determining if a first condition is true, and processing each first-frame datum for which the condition is true. The method comprises defining a first aperture boundary, comparing the associated coordinates of each datum of a first frame to the first boundary to determine if a first condition is true, and for each first-frame datum for which the condition is true, processing the first-frame datum. By repeatedly selecting image data for processing, the animation of window transitions may be achieved.

### BACKGROUND

1. Field of the Invention

This invention relates generally to image processing, and more particularly to a method and apparatus for writing a non-rectangular frame to a display device.

2. Description of the Background Art

Display devices based on Liquid Crystal Display (“LCD”), Cathode Ray Tube (“CRT”), and other technologies render an image on a rectangular display screen. The image on the display screen is formed from an array of small discrete picture elements known as pixels. The displayed image is rectangular because the pixels are conventionally organized as numerous lines of equal length. For instance, a 640×480 display screen has 480 lines, each of which is 640 pixels long. The attributes of each pixel, such as its brightness and color, are represented by a numeric data value, which is typically represented in binary form. An array of data pixels is often referred to as a frame or pixmap (for pixel map). Each pixel location in a frame can be identified by an x and y coordinate.

The use of rectangular frames is not limited to display devices. For example, a charge coupled device (“CCD”) is often used as an image sensor in digital cameras. The sensor typically includes a rectangular array of sensor pixels. Like the pixels in display devices, the pixels in a CCD are organized as numerous lines of equal length.

It is common to render more than one frame on a display device at a time. One example is a mobile telephone with an integral camera. A main frame and a camera frame can be displayed simultaneously. Typically, the main frame is a rectangle related to telephone functions having the same dimensions as the display screen and the camera frame is a rectangle having dimensions smaller than the display screen. On the display screen, the camera frame appears superimposed on the main frame. FIG. 1 illustrates this example of main and camera frames 100, 102 being displayed on a mobile telephone screen 104.

Because image capture and display devices generate and render rectangular frames, the protocols for transmitting and processing image data are typically designed for rectangular frames. In addition, when image data are stored in memory, it is common to allocate a physically rectangular portion of the memory for storage of the frame.

It is sometimes desirable, however, to display a non-rectangular image. Because the known protocols for transmitting, processing, and storing images are adapted for rectangular frames, they can be inefficient and wasteful of memory when it comes to non-rectangular images. In particular, they transmit and store data that is not ultimately displayed.

When a user decides to cause a camera frame to be displayed or to not be displayed on the screen of a hand-held, battery-powered computer appliance, such as a mobile telephone, the camera frame commonly appears or disappears instantly. This is true for any “window,” not only a window for displaying a camera frame. However, window transitions may be more pleasing to a viewer if the window changes size or position at a rate that renders the change perceivable as an animation.

Accordingly, a method and apparatus for writing a non-rectangular frame to a display device would be highly desirable. In addition, a method and apparatus for animating window transitions would be advantageous.

### SUMMARY

The invention is directed to an apparatus and method for writing a non-rectangular frame to a display device and for animating window transitions. In particular, the invention is directed to selecting image data of a first frame. By repeatedly selecting image data, the animation of window transitions may be achieved. Each first-frame datum has associated coordinates that are used in making the selection.

In a preferred embodiment, the apparatus comprises a memory for storing at least one parameter for defining a first aperture boundary in terms of a coordinate system, and a data selecting part. The data selecting part is adapted for comparing each first-frame datum's associated coordinates to the first boundary to determine if a first condition is true. Preferably, the first condition is one of whether the associated coordinates are inside or outside of the first boundary. The data selecting part is also adapted for processing each first-frame datum for which the condition is true. The processing is at least one of receiving, transmitting, or storing the first-frame datum. At least a portion of the first boundary is curvilinear.

In a preferred embodiment, the method comprises defining a first aperture boundary in terms of a coordinate system, comparing each of the first-frame datum's associated coordinates to the first boundary to determine if a first condition is true, and for each first-frame datum for which the condition is true, processing the first-frame datum. Preferably, the first condition is one of whether the associated coordinates are inside or outside of the first boundary. The processing of the first-frame datum is at least one of receiving, transmitting, or storing the first-frame datum. At least a portion of the boundary is curvilinear.

### BRIEF DESCRIPTION OF THE DRAWINGS

FIG. 1 illustrates main and camera frames being displayed on the screen of a mobile telephone.

FIG. 2 is a block diagram of a computer system for writing frames to a display device.

FIG. 3 is a block diagram of a computer system for writing a non-rectangular frame to a display device, which includes a geometric region resizer according to the invention.

FIG. 4 is block diagram of the geometric region resizer of FIG. 3.

FIG. 5 is a block diagram of a computer system for writing a non-rectangular frame to a display device according to an alternative embodiment of the invention.

FIG. 6 is a block diagram of a computer system for writing a non-rectangular frame to a display device according to another alternative embodiment of the invention.

FIG. 7 is a block diagram of a geometric region resizer according to an additional embodiment of the invention.

FIG. 8 is a diagram of main and camera frames being displayed on a screen that may be generated according to an embodiment of the invention which includes the geometric region resizer of FIG. 7.

FIG. 9a is a diagram of a rectangular camera frame and a circular aperture for defining a non-rectangular camera frame.

FIGS. 9b and 9c are diagrams of a display device rendering a rectangular main frame and non-rectangular camera frame.

FIG. 10 is a block diagram of a computer system for writing a non-rectangular frame to a display device according to another embodiment of the invention.

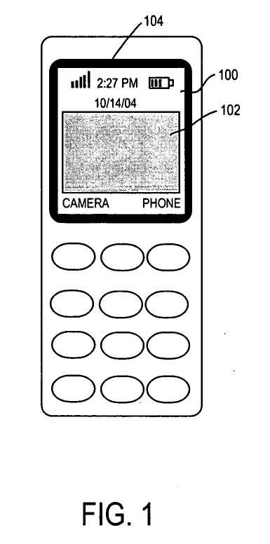

### DETAILED DESCRIPTION OF PREFERRED EMBODIMENTS

The invention is directed to a method and apparatus for writing a non-rectangular frame to a display device. Reference will now be made in detail to the present preferred embodiments of the invention, examples of which are illustrated in the accompanying drawings. Wherever possible, the same reference numbers are used in the drawings and the description to refer to the same or like parts.

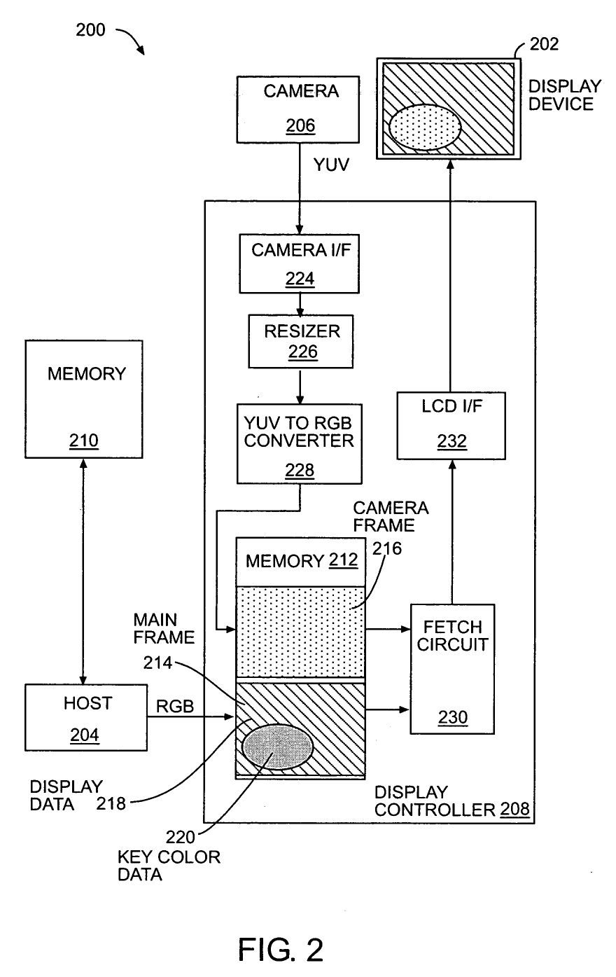

FIG. 2 illustrates some of the problems that the invention solves. FIG. 2 is a block diagram of a computer system 200 for writing frames to the system's display device 202. The system 200 can be used to write non-rectangular frames. In the system, a main frame originates with a host 204 and a camera frame originates with a camera 206. Both the host 204 and the camera 206 send their respective frames to a display controller 208, which is coupled to the display device 202. In addition, the system 200 includes a memory 210 coupled with the host 204.

The display controller 208 also has an internal memory 212. One region of the memory 212 is allocated for storing the main frame 214 and another region is allocated for storing the camera frame 216. The main frame 214 includes both display data 218 and “key color” data 220. The key color data 220 is organized in a desired non-rectangular aperture, such as an oval.

As mentioned, the host 204 is the source of the main frame 214. The host 204 specifies both the display data and the key color data. The host 204 may simply write the main frame to the display controller 208. Alternatively, the host 204 may store and then subsequently fetch the main frame 214 from the memory 210 before writing it to the display controller 208. The main frame 214 is always stored in the memory 212 as a rectangular pixmap.

Because the camera 206 typically does not include sufficient memory for storing a full camera frame, when it captures an image it generates a raster-ordered stream of image data in a YUV color format, which it transmits to a camera interface 224 in the display controller 208. A resizer 226 receives the data from the camera interface 224 and optionally performs image transformation operations, such as cropping and scaling the image. The resizer 226 writes transformed data to a YUV-to-RGB converter 228. The converter 228 converts the data to an RGB color format and stores the camera frame 216 in the memory 212. In the system 200, the camera frame 216 is always stored in the memory 212 as a rectangular pixmap.

In addition to the main and camera frames, another pixmap is referred to in this specification. The display screen of a display device is defined by a pixmap, which is referred to in this specification as the “display frame.” As with the main and camera frames, each pixel in the display frame is specified with by unique (x, y) coordinate pair. For purposes of illustrating the principles of the invention, the pixmaps of the main and camera frames are organized in such a way that there is a one-to-one correspondence between the pixels in these frames and one another, and with the display frame. For example, pixel (12, 17) of the main frame and pixel (12, 17) of the camera frame correspond to the pixel (12, 17) of the display frame.

A fetching circuit 230 reads the main frame from the memory 212 (typically in raster sequence), comparing each fetched, main-frame pixel with the binary value of the color-key pixel. If the fetched pixel does not equal the key color, it is written to a display device interface circuit 232 (“LCD I/F”). The LCD I/F 232 writes the pixels it receives to the display device 202. On the other hand, if the fetched, main-frame pixel matches the key color, the fetching circuit 230 reads a corresponding pixel from the camera frame 216. The pixel fetched from the camera frame 216 is written to the LCD I/F 232 instead of the fetched, main-frame pixel. The fetched, main-frame pixel is discarded. The “corresponding” camera pixel is from the same x, y coordinate location as the discarded main-frame pixel.

As mentioned, one region of the memory 212 is allocated for storing the main frame 214. The fetching circuit 230 reads the main frame from the memory 212 by reading the image data stored in the allocated region. The phrase “display-frame region” is used in this specification to particularly refer to the memory region allocated for storing a main frame, and to more generally refer to the memory region from which image data is read to refresh or update a display device.

Some of the disadvantages of the system 200, when used to write a non-rectangular camera frame to a display device, are as follows. First, this technique requires enough memory in the display controller 212 for two full rectangular frames. Second, the host 204 must generate a main frame with key color data that is organized in the desired non-rectangular aperture. This requires the host to perform substantial processing, consuming a significant number of CPU cycles. Third, the host must write numerous individuals pixels specifying the color key region to the display controller 208. Fourth, each time the non-rectangular aperture changes, the host 204 must re-write the entire main frame to the memory 212, even if the display data did not change and even if the change in aperture is relatively minor. This increases bus traffic and consumes memory bandwidth. Conservation of power is critical in battery-powered, mobile appliances, such as mobile telephones, and the required processing and memory increases power consumption.

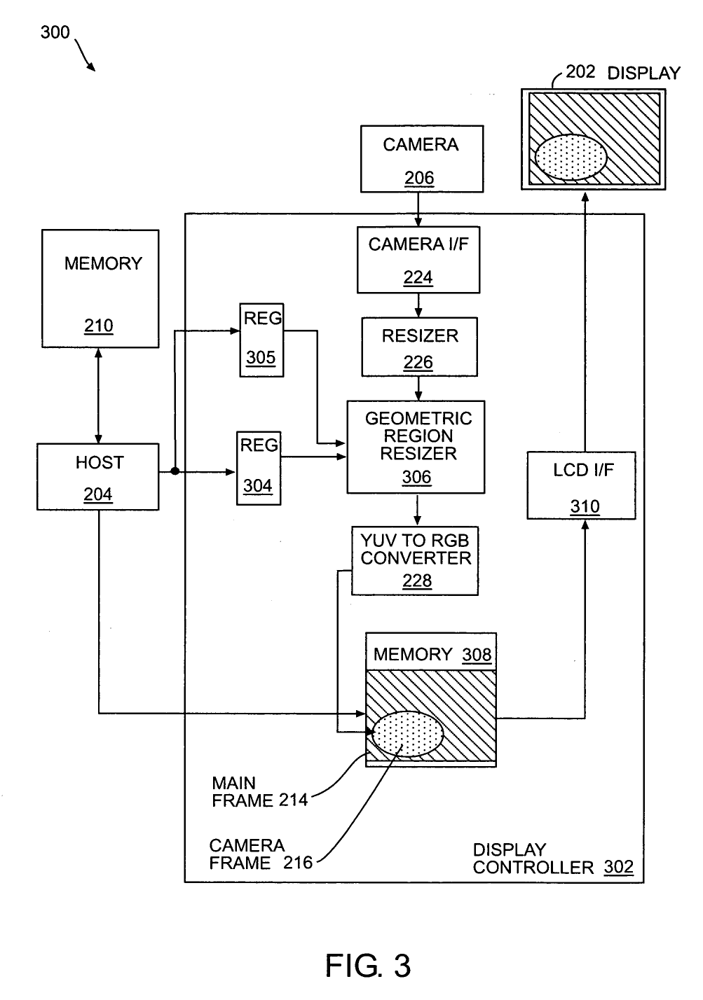

FIG. 3 is a block diagram of a computer system 300 for writing a non-rectangular frame to a display device according to one preferred embodiment of the invention. The system 300 includes the display device 202, the host 204, the camera 206, and a display controller 302. The display controller 302 is coupled to the host 204, to the camera 206, and to the display device 202. The display controller 302 includes the camera interface 224, the resizer 226, and the YUV-to-RGB converter 228. The display controller 302 also includes registers 304 and 305, a geometric region resizer 306, an internal memory 308, and an LCD I/F 310.

The camera 206 generates a raster stream of image data that it sends to the camera interface 224. The camera image data is passed along a data path that runs to the resizer 226, the geometric region resizer 306, the YUV-to-RGB converter 228, the memory 308, the LCD I/F 310, and finally to the display device 202. This data path is similar to that of the system 200. However, the data path in the system 300 additionally includes the geometric region resizer 306 and omits the fetching circuit 230. Furthermore, the memory 308 may be made smaller than the memory 212.

Preferably, the input block to the geometric region resizer 306 is the resizer 226, though this is not essential. The resizer 226 outputs pixels in a camera frame, which may be optionally scaled or cropped. Preferably, the resizer 226 also outputs each pixel's x and y coordinate values, though other means may be provided for providing pixel coordinates.

The binary data defining the pixel and the pixel's x and y coordinates are input to the geometric region resizer 306. The geometric region resizer 306 determines whether the received pixel should be passed onto the YUV-to-RGB converter 228 for subsequent storage in the internal memory 308. This determination is made on the basis of whether the pixel falls inside or outside of a non-rectangular aperture. Preferably, the non-rectangular aperture is either a circle or an ellipse.

Because the geometric region resizer 306 selects or discards pixels with reference to a circular or elliptical aperture, it is helpful to review some equations related to a circle and an ellipse before further explaining the operation of the geometric region resizer 306.

The radius of a circle is (r) and the coordinates of a circle's center are (x₀, y₀). The expression below, which is a version of the Pythagorean theorem in which the radius (r) of a circle is the hypotenuse, is true for all points lying a distance (r) from the center of the circle.
(x−x₀)²+(y−y₀)²=r² (1)
By replacing the equal sign with a comparator, such as “less than” (<) or “greater than” (>), the expression can be employed to determine whether a particular point having coordinates (x, y) is inside or outside of a circle.

The following expression relates a point having coordinates (x, y) to an ellipse:

$$\frac{1}{{a}^{2}} {( x - {x}_{0} )}^{2} + \frac{1}{{b}^{2}} {( y - {y}_{0} )}^{2} = 1 \qquad ( 2 )$$

The semi-major axis equals 2*a and the semi-minor axis equals 2*b. The coordinates of the center of the ellipse are (x₀, y₀). Rearranging terms:
b²(x−x₀)²+a²(y−y₀)²=a²b² (3)
The above expression is true for all points lying on the circumference of the ellipse. As with expression (1), replacing the equal sign with a comparator permits the expression to be employed to determine whether a particular point is inside or outside of an ellipse.

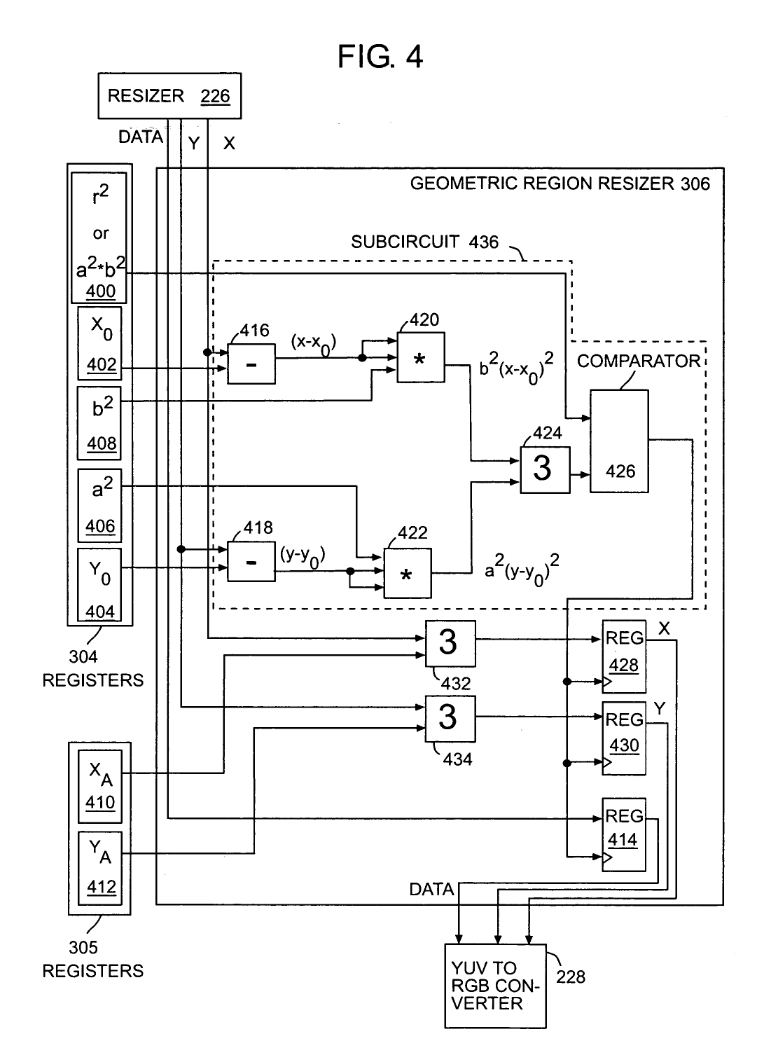

FIG. 4 is a block diagram of the geometric region resizer 306, and the registers 304 and 305 of FIG. 3. The geometric region resizer 306 transforms a rectangular frame into a non-rectangular frame that is defined by values stored in the registers 304. The registers 304 preferably comprise five registers: 400408. The host 204 defines the shape of a desired non-rectangular camera frame by writing appropriate values to the registers 400-408. The register 400 is for the radius squared (r²) or the quantity a²b². The registers 402, 404 are for the center coordinates (x₀, y₀). The registers 406, 408 are for the quantities a² and b², respectively. The registers 305 preferably comprise two registers: 410, 412. The registers 410, 412 are for storing the quantities X_{A} and Y_{A}, respectively. The variables X_{A} and Y_{A} specify memory address offsets.

As mentioned, the resizer 226 preferably generates the (x, y) coordinate values of each pixel it outputs. The pixel's x and y coordinate values correspond to x and y in equations (1)-(3). Each pixel that the resizer 226 outputs, along with the pixel's (x, y) coordinate values, are input to the geometric region resizer 306. Each pixel received from the resizer 226 is temporarily stored in a register 414. Each pixel's (x, y) coordinates are provided to the subtracters 416, 418, respectively. In addition, each pixel's (x, y) coordinates are provided to adders 432, 434.

The inputs of the registers 428, 430 are coupled to adders 432, 434, respectively. The registers 428, 430 are for storing the memory address of the pixel stored in register 414. The adder 432 sums the x coordinate with the X_{A} memory address offset stored in register 410, and adder 434 sums the y coordinate with the Y_{A} memory address offset stored in register 412.

The subtracters 416, 418 receive, respectively, the x and y coordinates of each pixel. The subtracters 416, 418 also receive, respectively, the x₀ and y₀ center coordinates stored in registers 402, 404. The subtracter 416 outputs (x−x₀) and the subtracter 418 outputs (y−y₀).

The quantities output from the subtracters 416, 418 are provided twice to the inputs of multipliers 420 and 422, respectively, in order to square the quantities. In addition, the quantities a² and b² stored in registers 406, 408, respectively, are provided to multipliers 420 and 422, respectively. The output of multiplier 420 is b²(x−x₀)² and the output of multiplier 422 is a²(y−y₀)², corresponding to the left-hand side of the equation (3) for an ellipse above.

If the desired shape is a circle, the host 204 stores “1's” for a² and b² in registers 406, 408, and the output of multiplier 420 is (x−x₀)² and the output of multiplier 422 is (y−y₀)², corresponding to the left-hand side of the equation (1) for a circle above.

The outputs of the multipliers 420 and 422 are input to an adder 424. The adder 424 outputs either the sum b²(x−x₀)²+a²(y−y₀)², or the sum (x−x₀)²+(y−y₀)², depending on whether an ellipse or a circle is desired. The sum that the adder 424 produces is input to a comparator 426. The value (r² or b²a²) stored in register 400 is also input to a comparator 426. The comparator 426 may perform any desired comparison on these two quantities, that is, >, <, >, <, =, or ≠. In one preferred embodiment, the comparator 426 performs a “less than” (<) comparison. In this embodiment, if the sum output by the adder 424 is less than the value stored in the register 400, the output of the comparator 426 is asserted, indicating that the pixel stored in register 414 is within the specified circle or ellipse. On the other hand, the output of the comparator 426 is not asserted if the sum output by adder 424 is greater than or equal to the value stored in the register 400, indicating the pixel stored in register 414 is to be discarded.

If the output of the comparator 426 is asserted, the pixel stored in register 414 is provided to the YUV-to-RGB converter 228. In addition, the output of comparator 426 is provided to registers 428 and 430, which, as mentioned, store the x and y coordinates of the memory address of the pixel. The assertion of the output signal of the comparator 426 causes the x and y coordinates stored in registers 428, 430 to also be provided to the YUV-to-RGB converter 228.

If the output of the comparator 426 is not asserted, the pixel and address data in registers 414, 428, and 430 are not provided to the YUV-to-RGB converter 228. This data is effectively discarded when the resizer 226 outputs a subsequent pixel, together with its coordinates, and overwrites the contents of these registers.

The components within the dashed line 436, namely, subtracters 416, 418, the multipliers 420, 422, the adder 424, and the comparator 426 are collectively referred to in this specification as sub-circuit 436. To summarize, the sub-circuit 436 asserts a signal if a particular pixel located at an (x, y) coordinate position in a frame satisfies a condition of comparison, i.e., it is within or outside a specified circular or elliptical aperture, depending on the particular comparative condition. Preferably, this signal is employed to cause particular pixels in a frame to be selected for further processing.

While not shown, it will be appreciated by one of ordinary skill in the art that various means for selecting the comparative condition to be applied by the comparator 426 may be provided so that the host may select any desired comparison. Of course, the comparator 426 may also be hard-wired to perform only a single comparative condition.

Referring again to FIG. 3, the geometric region resizer 306 writes selected pixels to the YUV-to-RGB converter 228, which converts the pixel to an RGB format and stores the pixel in the memory 308. In the first preferred embodiment, the YUV-to-RGB converter 228 stores the camera frame 216 as a non-rectangular pixmap in the display frame region of memory. The camera frame 216 is stored as a plurality of lines of varying length, each pixel being stored at its respective coordinate location.

Still referring to FIG. 3, the host 204 stores a main frame in the memory 308. The main frame includes the desired display data, but does not include color key data. In a preferred embodiment, the main frame is stored as a plurality of lines of the same length, that is, as a rectangular image. Although not essential, each pixel location in each line includes a display pixel. In addition, it is preferably that the host 204 stores the main frame 214 before the converter 228 stores the non-rectangular pixmap defining the camera frame 216. This is because the converter 228 overwrites a portion of the main frame 214. That is, the converter 228 by writes the non-rectangular camera frame 216 into the display frame region of memory where the main frame is stored after the host 204 has stored the main frame.

The LCD I/F 310 reads the image data stored in the display frame region of the memory 308 in raster sequence and writes the display frame to the display device 202. The LCD I/F 310 differs from the LCD I/F 232 in that the latter, as described above, compares fetched pixels with a key color and performs action based on the result of the comparison.

The system 300 is more desirable than the system 200 for several reasons. First, the memory 308 need not be as large the memory 212. The memory 212 needs to be large enough to store two full frames. However, the memory 308 only needs to be large enough for storing one full frame. In addition, the display interface is simpler. Another benefit is that the tasks that the host 204 must perform to display a non-rectangular camera frame are much simplified in comparison to the system 200. The host 204 simply writes a main frame containing only display data for storage in memory 308 and writes values to registers 304 for defining the desired circular or elliptical aperture.

As mentioned, the host 204 preferably stores the main frame 214 before the YUV-to-RGB converter 228 stores the non-rectangular pixmap defining the camera frame 216. This permits the converter 228 to overwrite a portion of the main frame. Alternative embodiments permit the host 204 to store the main frame 214 after or simultaneously with the storing of the camera frame 216 by the converter 228. Two such alternative embodiments are explained next.

In one alternative embodiment, software may be employed to cause the host 204 to store a main frame that only includes display data in particular portions of the display frame. Such software would be similar to that employed in the technique for writing a main frame that includes display and key color data described above. For example, assuming that the desired condition is a “less than” comparison, the host 204 stores main frame data only outside of the desired non-rectangular aperture. In other words, the main frame 214 written by the host does not include display data in portions within the non-rectangular aperture where the camera frame 216 is stored.

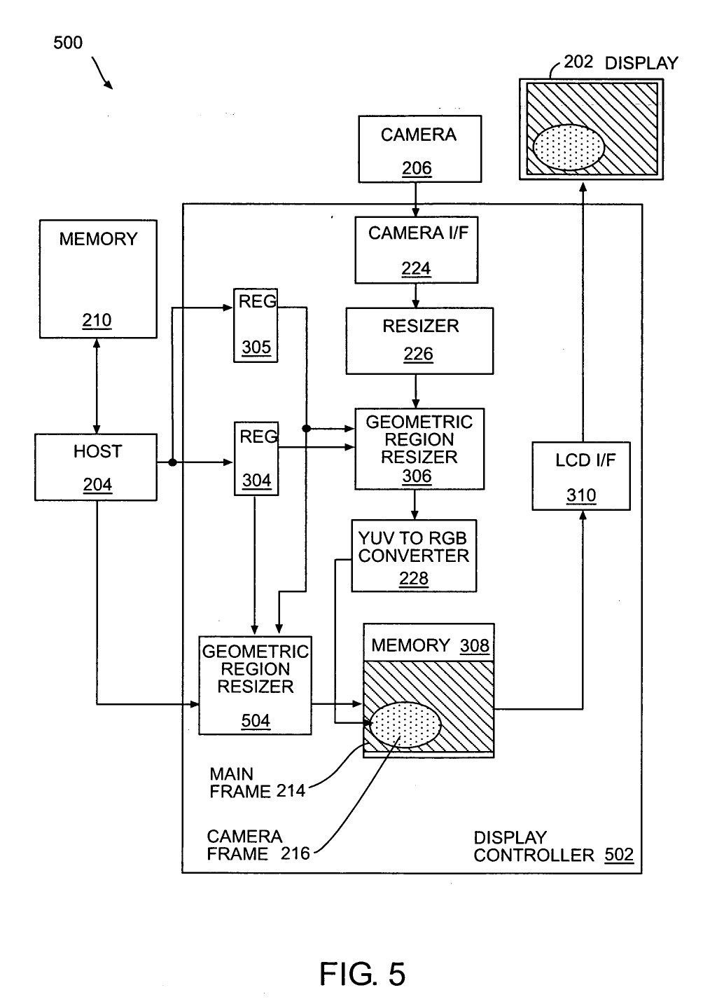

Referring to FIG. 5, another alternative embodiment for ensuring that the main frame 214 does not include display data in portions within the non-rectangular aperture is shown. In this embodiment, a second geometric region resizer is provided and placed into the data path between the host 204 and memory 308. This alternative is depicted in FIG. 5 as system 500, which includes a display controller 502 having a second geometric region resizer 504. The system 500 also includes a camera 206, a camera interface 224, and a resizer 226. The resizer 226 is coupled to the geometric region resizer 306.

The geometric region resizer 504 is similar to the geometric region resizer 306, except that the comparison operation performed by the geometric region resizer 504 is the complement of the comparison performed by the geometric region resizer 306. For instance, if the resizer 306 performs a “less than” comparison, the resizer 504 performs a “greater than or equal to” comparison. Conversely, if the resizer 306 performs a “greater than” comparison, the resizer 504 performs a “less than or equal to” comparison. More generally, a first and second condition are said to be “complementary conditions”, as that phrase is used in this specification, when the first condition selects a first set of all pixels that do not belong to a second set of pixels, and the second condition selects the set of all pixels that do not belong to the first set, where the first and second sets together define a frame, which is preferably, but not necessarily a display frame.

In operation, the geometric region resizer 306 operates as described above, storing a non-rectangular camera frame 216 in the display frame region of the memory 308. The host 204 writes a main frame to the geometric region resizer 504. Each pixel that the host 204 writes is compared to the non-rectangular geometric aperture specified by the values stored in registers 304. If, continuing the example of the preceding paragraph, the pixel's x and y coordinates are greater than or equal to those defining the non-rectangular geometric aperture, the main frame pixel is stored in the memory 308. Otherwise, the pixel is discarded and the geometric region resizer 504 does not store any data at that particular x and y coordinate in the display frame, thereby preserving the camera frame data stored at that (x, y) coordinate location.

It can be seen that the system 500 presents no risk of main frame data overwriting camera frame data. Accordingly, the host 204 and the converter 228 may store their respective frames in any order or simultaneously when the system 500 is employed.

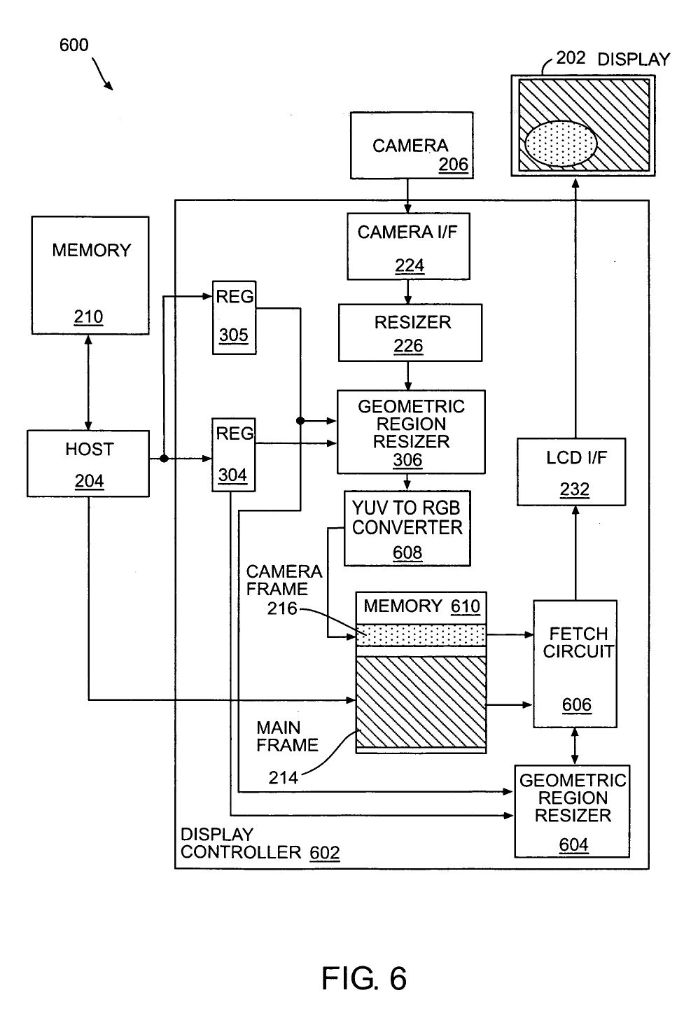

FIG. 6 is a block diagram of a computer system 600 according to another preferred embodiment of the invention. The system 600 generates a non-rectangular camera frame in a manner similar to the systems 300 and 500, but the non-rectangular camera frame is stored in a separate, linear portion of memory.

Referring to FIG. 6, the system 600 includes a display controller 602. The system 600 also includes the camera 206, the host 204, and a memory 210. The display controller 602 includes a camera interface 224, and a resizer 226, and a geometric region resizer 306. Further, the system 600 includes the registers 304 and 305. In addition, the system 600 includes a YUV-to-RGB converter 608, a memory 610, and a display interface 232. In contrast to the systems 300 and 500, the display controller 602 includes a second geometric region resizer 604 that is coupled to a fetch circuit 606.

The geometric region resizer 604 is similar to the geometric region resizer 306. The geometric region resizer 604 is coupled to the registers 305 and it performs the same comparison operation with respect to the same non-rectangular aperture as that performed by the geometric region resizer 306. The fetch circuit 606 generates a pixel addresses in raster sequence and such addresses are compared in the same manner to the geometric aperture specified in the registers 305.

In operation, the host 204 writes the desired parameters to registers 304, 305. In addition, the host 204 writes a main frame 214 containing only display data for storage in the display frame region of the memory 610. Preferably, the host 204 writes a full main frame 214, but it may alternatively write a main frame which excludes display data within the portion of the display frame reserved for the non-rectangular camera frame. The resizer 226 sends a camera frame to the geometric region resizer 306. The geometric region resizer 306 sends a non-rectangular camera frame 216 to a YUV-to-RGB converter 608, which after color format converting, writes the camera frame to a memory 610. The non-rectangular camera frame that the resizer 226 sends is based on the parameters stored in registers 305.

Unlike the systems 300 and 500, the YUV-to-RGB converter 608 of system 600 writes the non-rectangular camera frame 216 to a rectangular region of the memory 610. In addition, this region is a separate region from the display frame region where the main frame 214 is stored.

The fetch circuit 606 selects pixels of the main-frame 214 for fetching from the memory 610 in raster sequence. The geometric region resizer 604, which is coupled to the fetch circuit 606, evaluates the x and y coordinates of each selected main-frame pixel and provides a signal to the fetch circuit 606 indicating whether the camera image pixel is to overlay the main pixel in the display frame. The x and y coordinates are evaluated based on the parameters stored in registers 305. If the geometric region resizer 604 signals that the selected pixel is not part of the non-rectangular camera frame, the selected main-frame pixel is fetched from memory 610 and written to a display device interface circuit 232, which writes the pixels it receives to the display device 202. On the other hand, if the geometric region resizer 604 signals that the selected main-frame pixel is to be overlaid with a pixel of the non-rectangular camera frame 216, the fetch circuit fetches the corresponding pixel from the memory 610 and writes it to a display device interface circuit 232. The “corresponding” camera pixel is from the same x, y coordinate location as the selected main-frame pixel.

For example, if the geometric region resizer 306 generates a non-rectangular camera frame defined by all camera-frame pixels within a specified elliptical aperture, the converter 608 will store the pixels included in that camera frame in a linear portion of the memory 216. When the fetch circuit 606 selects the (x, y) coordinates of a pixel for which there is a corresponding pixel within the specified elliptical aperture, the geometric region resizer 604 sends a signal to the fetch circuit 606 causing it to fetch a camera-frame pixel instead of a main-frame pixel. The display frame that the fetch circuit 606 provides to the display interface 232 thus includes the elliptical camera frame 216 overlaying the rectangular main-frame 214.

Several benefits of the system 600 are readily apparent. The memory 610 need not be large enough to store two full frames. The memory 610 need only be large enough for storing one rectangular frame and one non-rectangular frame. Another benefit is that the tasks that the host 204 must perform to display the non-rectangular camera frame are much simplified in comparison to the system 200. The host 204 simply writes a main frame containing only display data for storage in memory 308 and writes the desired values to registers 304. It was mentioned above with respect to the system 300 that care must be taken so that the host 204 does not overwrite camera frame data. A further benefit of the system 600 is that overwriting camera frame data with the main frame data is not a concern. Accordingly, main and camera frames may be stored in any temporal sequence.

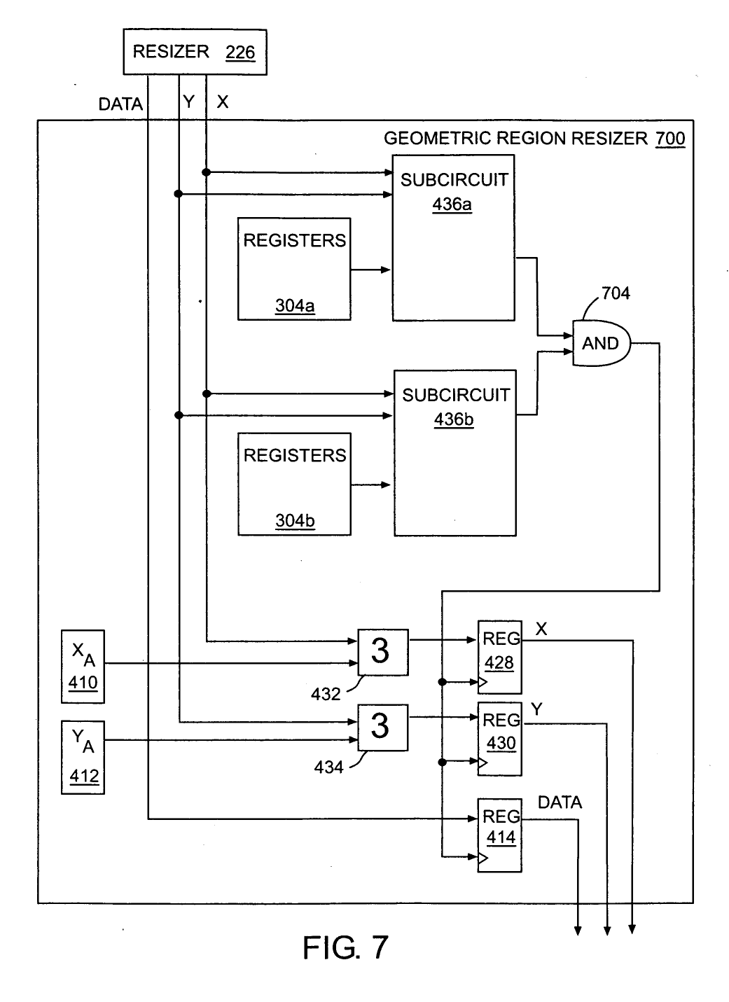

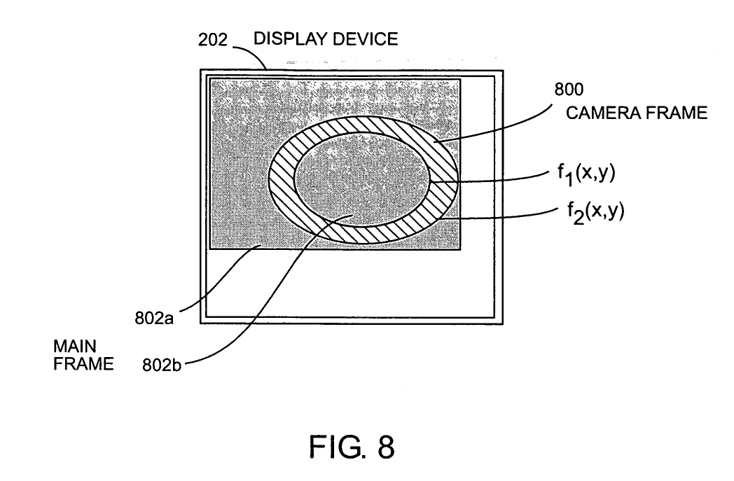

FIGS. 7 and 8 illustrate another preferred embodiment of the invention. This embodiment is directed generally to creating a ring-shaped camera frame. FIG. 7 is block diagram of a geometric region resizer 700 in accordance with this embodiment. FIG. 8 illustrates the display device 202 displaying a display frame when the geometric region resizer 700 is employed.

Preferably, the geometric region resizer 700 is employed in place of the geometric region resizer 306 in the system 300, which is shown in FIG. 3. For this reason, the geometric region resizer 700 is next described in this specification with reference to FIGS. 3, 4, 7, and 8. It will be appreciated, however, that the geometric region resizer 700 may be employed in a variety of other computer systems and configurations.

Referring to FIG. 7, the resizer 226 provides pixels and (x, y) coordinates to the geometric region resizer 700. The output of the geometric region resizer 700 is provided to the YUV-TO-RGB converter 228.

Referring to FIG. 8, it can be seen that the ring-shaped camera frame is defined by an outer non-rectangular aperture (an ellipse) and an inner non-rectangular aperture (also an ellipse). Referring to FIG. 7, the geometric region resizer 700 includes two instances of the sub-circuit 436, one for generating the outer non-rectangular aperture and another for generating the inner non-rectangular aperture. More particularly, it includes the sub-circuits 436a, 436b. The sub-circuits 436a, 436b have their outputs coupled to the inputs of an AND gate 704.

In addition, the geometric region resizer 700 includes two instances of the registers 304. More particularly, it also includes the registers 304a, 304b. The registers 304a are for storing parameters that define a first circular or elliptical aperture, and the registers 304b are for storing parameters that define a second circular or elliptical aperture. As before, the host 204 writes parameters to the registers 304a, 304b for defining the first and second apertures.

Referring again to FIG. 8, a non-rectangular camera frame 800 appears superimposed on a main frame 802 on the display screen. The main frame 800 appears to have two portions 802a, 802b. Recall that parameters that define a first circular or elliptical aperture are stored in the registers 304a. The first circular or elliptical aperture is referenced as f₁(x, y) in FIG. 8. The second circular or elliptical aperture is referenced as f₂(x, y) in FIG. 8. Parameters that define the second circular or elliptical aperture are stored in the registers 304b.

The AND gate 704 has its output coupled to inputs of the registers 414, 430, and 428, which are arranged, as shown in FIG. 7, in a manner similar to that of the geometric region resizer 306, shown in FIG. 4. The inputs of the registers 414, 430, and 428 to which the AND output is coupled are ones that cause the values stored in these register to be transferred to their outputs.

The geometric region resizer 700 additionally includes the registers 410, 412, the adders 432, 434.

In operation, camera frame pixels and their (x, y) coordinates are provided geometric region resizer 700. The x and y coordinates are provided to the sub-circuits 436a and 436b. Like the sub-circuit 436, the sub-circuits 436a and 436b can perform any desired comparison. However, the sub-circuits 436a and 436b preferably do not perform the same comparison. Instead, they perform different comparisons with reference to different apertures.

Each camera frame pixel is temporarily stored in the register 414. The pixel's x and y coordinates are evaluated by the comparators 436a, 436b. As an example, the comparator 436a performs a “less than” comparison and the comparator 436b performs a “greater than” comparison. If the (x, y) coordinate defines a pixel location: (a) within the second elliptical aperture, and (b) outside the first elliptical aperture, then the output of the AND gate 804 is asserted and the pixel is written to the YUV-to-RGB converter. Otherwise the pixel is discarded, and the corresponding main frame pixel is written to the display device 202.

As with the system 300, the host 204 also writes a main frame containing only display data for storage in the internal memory of the display controller.

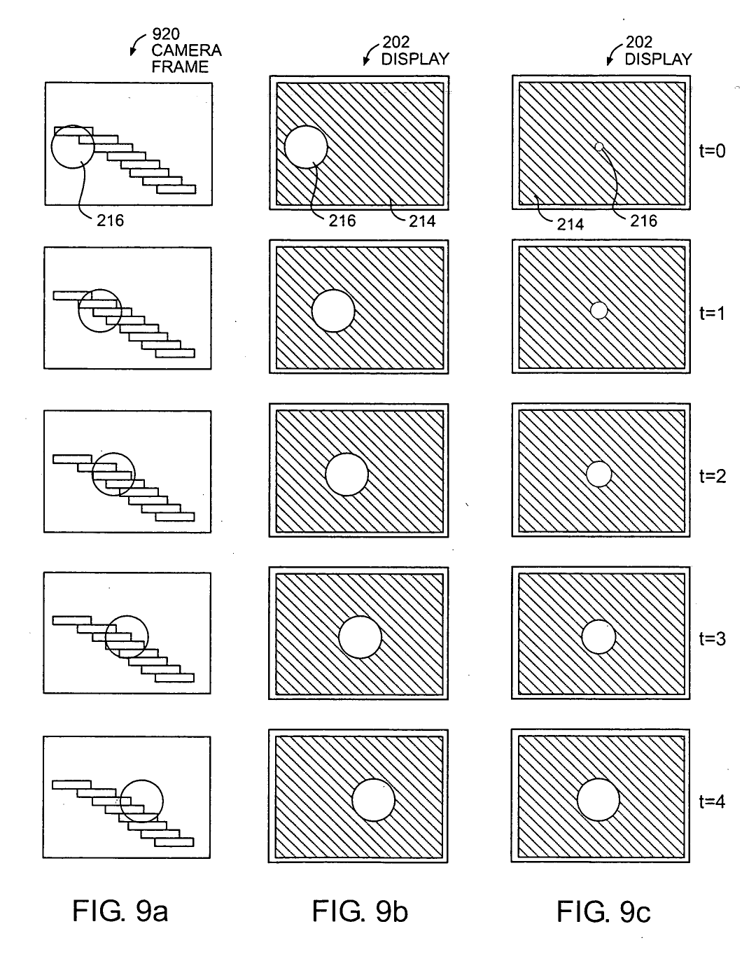

Preferred embodiments of the invention for animating window transitions are next described. FIGS. 9a, 9b, and 9c illustrate several representative window animations. Each figure includes 5 images at 5 successive points in time. If the frames were viewed in rapid succession, an animation would be perceived.

FIG. 9a shows a rectangular camera frame 920 and a circular aperture for defining a non-rectangular camera frame 216. The aperture moves horizontally with time. As the aperture moves to the right, different portions of the rectangular camera frame 920 are included within the circular camera frame 216.

FIGS. 9b and 9c show a display device 202 rendering main and non-rectangular camera frames 214, 216, respectively. In FIG. 9b, the camera frame 216 appears to move to the right. The shown camera frame 216 may include the same image data at each successive position. Alternatively, the camera frame 216 may include different image data at successive positions, such as shown in FIG. 9a.

FIG. 9c shows a camera frame 216 changing in size with time. The shown frame 216 grows larger with time, but it may also diminish in size with time. The camera frame 216 may include static or changing image data.

Referring again to FIG. 6, a window animation or transition, in one preferred embodiment is described: The host 204 writes parameters to the registers 305 for defining a non-rectangular camera frame. The camera frame 216 is selected and stored in a rectangular region of the memory 610. After the camera frame 216 is stored, the host 204 may write a series of new parameters to the registers 305 at successive points in time. The host 204 may write parameters at any desired frequency. Each new set of parameters specifies a successive position or dimension or both for the camera frame. As one example, the host 204 may specify the animation depicted in FIG. 9b by repeatedly updating the center coordinate parameters. In another example, the host 204 may specify the animation depicted in FIG. 9c by repeatedly updating the radius parameter.

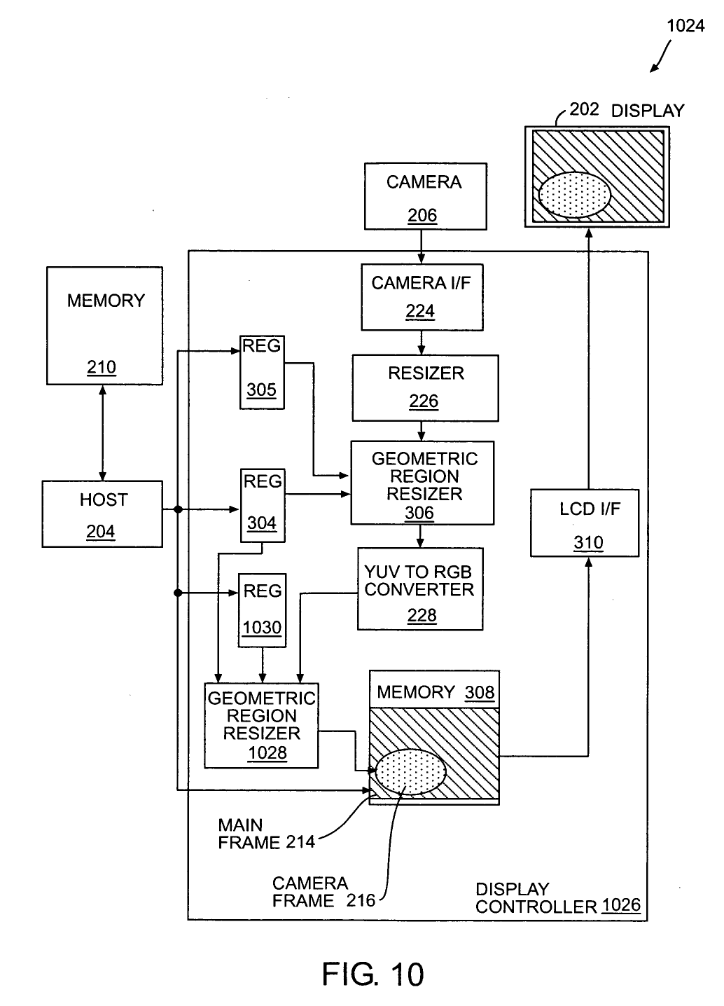

FIG. 10 illustrates a system 1024, which is another preferred embodiment for implementing a window animation or transition. The system 1024 includes a display controller 1026 having first and second geometric region resizers 306, 1028, respectively. The geometric region resizer 1028 is similar to the geometric region resizer 306, except that it is coupled to a register 1030 instead of the register 305. The register 1030 is similar to the register 305. The host 204 writes parameters to the register 305 for defining how a non-rectangular camera frame is to be selected from a rectangular camera frame. In addition, the host 204 writes parameters to the register 1028 for defining the position and dimensions of the non-rectangular camera frame. As one example, the host 204 may specify the animation depicted in FIG. 9b by repeatedly updating the center coordinate parameter stored in the register 1030. In another example, the host 204 may specify the animation depicted in FIG. 9c by repeatedly updating the radius parameter stored in register 1030. Moreover, by repeatedly updating the center coordinate parameter stored in register 305, the host 204 may specify the animation depicted in FIG. 9b, in which different image data appear at successive positions of the camera frame, such as shown in FIG. 9a. More generally, it will be appreciated that by repeatedly updating parameters with time, the host can cause a frame to be translated or rotated.

The method and apparatus for writing a non-rectangular frame to a display device and for animating window transitions may be advantageously employed in conjunction with known techniques for scaling an image. For instance, the size of a digital image may be doubled by duplicating each pixel in a row and duplicating each row. As an example of how scaling could be employed, recall in the preceding paragraph where it was stated with reference to FIG. 10 that the parameters in register 305 define how a non-rectangular camera frame is to be selected and the parameters in the register 1028 define the position and dimensions of the non-rectangular camera frame. Assume that the aperture defined in register 305 is one-half the size of the aperture defined by register 1028. A scaling circuit could be employed to double the size of the selected camera frame so that is fills the camera frame stored in memory.

The computer systems described in this specification are preferable battery-powered portable computer systems, such as a personal digital assistant or cellular telephone. However, the term “computer system” is used in this specification to broadly refer to any of a wide variety of devices, including but not limited to mainframe, personal, server, and embedded computers.

In this specification the host 204 may be any type of processor or CPU, and the term “host” is used in this specification to broadly refer to any of such processors, CPUs, digital signal processors, or other similar devices. Similarly, the term central processing unit or CPU is considered synonymous with host.

The term “camera” is used in this specification to broadly refer to any of a wide variety of image capture devices, including but not limited to still and video cameras, image scanners, and other similar devices. The term “camera” may also include any source of a digital image, such as a network interface or a JPEG decoder.

The registers 304, 305 for storing parameters have been shown and described as being separate from the memories 308, 610. This representation was for clarity of explanation only. It will be appreciated that the parameters stored in registers 304, 305 may be stored in the memories 308, 610, within the geometric resizers 306, 700, or elsewhere as desired.

The display device 202 is preferably an LCD. The term “display device” is used in this specification to broadly refer to any of a wide variety of devices for rendering images. The term display device is intended to also include hardcopy devices, such as printers and plotters. The term display device additionally refers to all types of display devices, such as CRT, LED, OLED, and plasma, without regard to the particular display technology employed.

For convenience of explanation and in accordance with the use of the term in the art, the term “pixel” has been used in this specification to refer at times to the display elements of a display device, at times to the binary elements of data that are stored and manipulated within a computer system and which define the attributes of such display elements, and at times to both, the appropriate sense of the term being clear from the context. The term has also been used to refer to sensor elements for sensing a pixel.

The phrase “camera frame” has been used in this specification to refer the frame of image data created by a camera and operated on by the geometric region resizer of the invention. Further, phrase “main frame” has been used in this specification to refer the frame of image data created by the host and which may or may not be processed using the geometric region resizer of the invention. It should be appreciated that these phrases are employed herein solely for convenience of explanation. The principles of the invention are applicable to any situation where two frames of image data are to be combined into a single display frame having a non-rectangular frame overlaying a rectangular frame, without regard to the sources of or labels given the respective frames. For example, the principles of the invention may be applied to create a non-rectangular main frame overlaying a rectangular camera frame. Moreover, the principles of the invention are applicable to any situation where the creation of a single a non-rectangular frame is desired. In other words, while preferable, it is not essential that two frames of image data be combined into a single display frame.

While the invention has been illustrated with respect to particular blocks and modules, it will be appreciated that the method of the invention may be also be embodied as a program of instructions and stored in a medium readable by a device which is adapted to perform such instructions. For example, a display controller according an alternative embodiment of the invention may include a CPU block adapted to execute a program of instructions stored in a memory. In this example, the embedded CPU performs any of the comparing, selecting, discarding, reading, writing, and other operations related to generating a non-rectangular frame that have been described in this specification.

The embodiments described in this specification are for purposes of illustration and not intended to be exhaustive or limiting. Many variations and modifications are possible in light of the teachings in this specification. Further, the terms and expressions employed in this specification have been used as terms of description and not of limitation, and are not intended to exclude equivalents of the features shown and described or portions of them. The scope of the invention is defined and limited only by the claims that follow.

1. A method for selecting image data of a first frame, each first-frame datum having associated coordinates in a coordinate system for locating a point with at least two coordinates, the method comprising the steps of:
defining a first aperture boundary in terms of the coordinate system;
comparing each of said first-frame datum's associated coordinates to said first boundary to determine if a first condition is true, said first condition being one of whether said associated coordinates are (a) inside and (b) outside of said first boundary; and
processing each of said first-frame datum for which said condition is true, said processing being at least one of (a) receiving, (b) transmitting, and (c) storing, wherein at least a portion of said boundary is curvilinear.

2. The method of claim 1, wherein at least a portion of said first boundary is circular.

3. The method of claim 1, wherein at least a portion of said first boundary is elliptical.

4. The method of claim 1, wherein said step of processing comprises storing each said first-frame datum in a display frame region of a memory.

5. The method of claim 4, further comprising a step of storing a second frame in said display frame region.

6. The method of claim 5, further comprising a step of writing each of said data stored in said display frame region to a display device.

7. The method of claim 5, wherein said step of storing a second frame is performed before storing each said first-frame datum in a display frame region of a memory.

8. The method of claim 7, further comprising a step of writing each of said data stored in said display frame region to a display device.

9. The method of claim 5, wherein said step of storing a second frame comprises comparing each second-frame datum's associated coordinates to said first boundary to determine if a second condition is true, said second condition being the complement of said first condition, and only storing each said second-frame datum for which said second condition is true.

10. The method of claim 9, further comprising a step of writing each of said data stored in said display frame region to a display device.

11. The method of claim 1, wherein said step of processing comprises storing each said first-frame datum for which said condition is true in a rectangular region of a memory.

12. The method of claim 11, further comprising a step of writing each said first-frame datum stored in said rectangular region to a display device.

13. The method of claim 12, further comprising a step of comparing the associated coordinates of each data of a second frame to said first boundary to determine if said first condition is false, and writing to said display device each said second-frame datum for which said first condition is false.

14. The method of claim 1, further comprising:
defining a second aperture boundary in terms of the coordinate system;
comparing each said first-frame datum's associated coordinates to said second boundary to determine if a second condition is true, said second condition being one of whether said associated coordinates are (a) inside and (b) outside of said boundary; and
processing each of said first-frame datum for which said condition is true, said processing being at least one of (a) receiving, (b) transmitting, and (c) storing, wherein at least a portion of said boundary is curvilinear.

15. The method of claim 1, further comprising at least one of the steps of: (a) translating, (b) rotating, and (c) scaling said coordinate values for further selecting the data.

16. The method of claim 15, further comprising performing said at least one step at a plurality of sequential time intervals, thereby rendering an animation.

17. A medium readable by a machine embodying a program of instructions executable by the machine to perform a method for selecting image data of a first frame, each first-frame datum having associated coordinates in a coordinate system for locating a point with at least two coordinates, the method comprising the steps of:
defining a first aperture boundary in terms of the coordinate system;
comparing each of said first-frame datum's associated coordinates to said first boundary to determine if a first condition is true, said first condition being one of whether said associated coordinates are (a) inside and (b) outside of said first boundary; and
processing each of said first-frame datum for which said condition is true, said processing being at least one of (a) receiving, (b) transmitting, and (c) storing, wherein at least a portion of said boundary is curvilinear.

18. The medium of claim 17, wherein at least a portion of said first boundary is circular.

19. The medium of claim 17, wherein at least a portion of said first boundary is elliptical.

20. The medium of claim 17, wherein said step of processing comprises storing each said first-frame datum in a display frame region of a memory.

21. The medium of claim 20, further comprising a step of storing a second frame in said display frame region.

22. The medium of claim 21, further comprising a step of writing each of said data stored in said display frame region to a display device.

23. The medium of claim 21, wherein said step of storing a second frame is performed before storing each said first-frame datum in a display frame region of a memory.

24. The medium of claim 23, further comprising a step of writing each of said data stored in said display frame region to a display device.

25. The medium of claim 21, wherein said step of storing a second frame comprises comparing each second-frame datum's associated coordinates to said first boundary to determine if a second condition is true, said second condition being the complement of said first condition, and only storing each said second-frame datum for which said second condition is true.

26. The medium of claim 25, further comprising a step of writing each of said data stored in said display frame region to a display device.

27. The medium of claim 17, wherein said step of processing comprises storing each said first-frame datum for which said condition is true in a rectangular region of a memory.

28. The medium of claim 27, further comprising a step of writing each said first-frame datum stored in said rectangular region to a display device.

29. The medium of claim 28, further comprising a step of comparing the associated coordinates of each data of a second frame to said first boundary to determine if said first condition is false, and writing to said display device each said second-frame datum for which said first condition is false.

30. The medium of claim 17, further comprising:
defining a second aperture boundary in terms of the coordinate system;
comparing each said first-frame datum's associated coordinates to said second boundary to determine if a second condition is true, said second condition being one of whether said associated coordinates are (a) inside and (b) outside of said boundary; and
processing each of said first-frame datum for which said condition is true, said processing being at least one of (a) receiving, (b) transmitting, and (c) storing, wherein at least a portion of said boundary is curvilinear.

31. The medium of claim 17, further comprising at least one of the steps of: (a) translating, (b) rotating, and (c) scaling said coordinate values for further selecting the data.

32. The medium of claim 17, further comprising performing said at least one step at a plurality of sequential time intervals, thereby rendering an animation.

33. An apparatus for selecting image data of a first frame, each first-frame datum having associated coordinates in a coordinate system for locating a point with at least two coordinates, comprising:
a memory for storing at least one parameter for defining a first aperture boundary in terms of the coordinate system; and
a data selecting part for comparing each first-frame datum's associated coordinates to said first boundary to determine if a first condition is true, said first condition being one of whether said associated coordinates are (a) inside and (b) outside of said first boundary, and for processing each of said first-frame datum for which said condition is true, said processing being at least one of (a) receiving, (b) transmitting, and (c) storing, wherein at least a portion of said first boundary is curvilinear.

34. The apparatus of claim 33, wherein at least a portion of said first boundary is circular.

35. The apparatus of claim 33, wherein at least a portion of said first boundary is elliptical.

36. The apparatus of claim 33, wherein said data selecting part is further adapted for storing each said first-frame datum for which said condition is true in a display frame region of said memory.

37. The apparatus of claim 36, further comprising a data storing part for storing a second frame in said display frame region.

38. The apparatus of claim 37, further comprising a data writing part for writing each of said data stored in said display frame region to a display device.

39. The apparatus of claim 37, wherein said data storing part is adapted to store said second frame before said data processing part stores each said first-frame datum in said display frame region.

40. The apparatus of claim 39, further comprising a data writing part for writing each of said data stored in said display frame region to a display device.

41. The apparatus of claim 37, wherein said data storing part is further adapted for comparing each second-frame datum's associated coordinates to said first boundary to determine if a second condition is true, said second condition being the complement of said first condition, and for only storing each said second-frame datum for which said second condition is true.

42. The apparatus of claim 41, further comprising a data writing part for writing each of said data stored in said display frame region to a display device.

43. The apparatus of claim 33, wherein said data selecting part is further adapted for storing each said first-frame datum for which said condition is true in a rectangular region of said memory.

44. The apparatus of claim 43, further comprising a data writing part for writing each said first-frame datum stored in said rectangular region to a display device.

45. The apparatus of claim 44, wherein said data writing part is further adapted for comparing the associated coordinates of each datum of a second frame to said first boundary to determine if said first condition is false, and writing to said display device each said second-frame datum for which said first condition is false.

46. The apparatus of claim 33, wherein:
said memory is further adapted for storing at least one parameter for defining a second aperture boundary in terms of the coordinate system; and
said data selecting part is further adapted for comparing each said first-frame datum's associated coordinates to said second boundary to determine if a second condition is true, said second condition being one of whether said associated coordinates are (a) inside and (b) outside of said second boundary, and for processing each of said first-frame datum for which both said first and second conditions are true, said processing being at least one of (a) receiving, (b) transmitting, and (c) storing, wherein at least a portion of said second boundary is curvilinear.

47. The apparatus of claim 33, wherein said data selecting part is further adapted for performing at least one of: (a) translating, (b) rotating, and (c) scaling said coordinate values for further selecting the data.

48. A system for selecting image data of a first frame, each first-frame datum having associated coordinates in a coordinate system for locating a point with at least two coordinates, comprising:
a central processing unit;
a camera;
a display device;
a power supply for providing power from at least one battery;
a memory for storing at least one parameter for defining a first aperture boundary in terms of the coordinate system; and
a data selecting part for comparing each first-frame datum's associated coordinates to said first boundary to determine if a first condition is true, said first condition being one of whether said associated coordinates are (a) inside and (b) outside of said first boundary, and for processing each of said first-frame datum for which said condition is true, said processing being at least one of (a) receiving, (b) transmitting, and (c) storing, wherein at least a portion of said first boundary is curvilinear.

49. The system of claim 48, wherein at least a portion of said first boundary is circular.

50. The system of claim 48, wherein at least a portion of said first boundary is elliptical.

51. The system of claim 48, wherein said data selecting part is further adapted for storing each said first-frame datum for which said condition is true in a display frame region of said memory.

52. The system of claim 36, further comprising a data storing part for storing a second frame in said display frame region.

53. The system of claim 52, further comprising a data writing part for writing each of said data stored in said display frame region to said display device.

54. The system of claim 52, wherein said data storing part is adapted to store said second frame before said data processing part stores each said first-frame datum in said display frame region.

55. The system of claim 54, further comprising a data writing part for writing each of said data stored in said display frame region to said display device.

56. The system of claim 52, wherein said data storing part is further adapted for comparing each second-frame datum's associated coordinates to said first boundary to determine if a second condition is true, said second condition being the complement of said first condition, and for only storing each said second-frame datum for which said second condition is true.

57. The system of claim 56, further comprising a data writing part for writing each of said data stored in said display frame region to said display device.

58. The system of claim 48, wherein said data selecting part is further adapted for storing each said first-frame datum for which said condition is true in a rectangular region of said memory.

59. The system of claim 58, further comprising a data writing part for writing each said first-frame datum stored in said rectangular region to said display device.

60. The system of claim 59, wherein said data writing part is further adapted for comparing the associated coordinates of each datum of a second frame to said first boundary to determine if said first condition is false, and writing to said display device each said second-frame datum for which said first condition is false.

61. The system of claim 48, wherein:
said memory is further adapted for storing at least one parameter for defining a second aperture boundary in terms of the coordinate system; and
said data selecting part is further adapted for comparing each said first-frame datum's associated coordinates to said second boundary to determine if a second condition is true, said second condition being one of whether said associated coordinates are (a) inside and (b) outside of said second boundary, and for processing each of said first-frame datum for which both said first and second conditions are true, said processing being at least one of (a) receiving, (b) transmitting, and (c) storing, wherein at least a portion of said second boundary is curvilinear.

62. The system of claim 48, wherein said data selecting part is further adapted for performing at least one of: (a) translating, (b) rotating, and (c) scaling said coordinate values for further selecting the data.
